(19) United States
(12) Patent Application Publication
(10) Pub. No.: US 2014/0072153 A1
(43) Pub. Date: Mar. 13, 2014

(54) SIMULATED SOUND FIELD EARPHONE

(71) Applicants: Chu Ming Chung, New Taipei City (TW); Lee Pin Tang, New Taipei City (TW)

(72) Inventors: Chu Ming Chung, New Taipei City (TW); Lee Pin Tang, New Taipei City (TW)

(73) Assignee: Eastern Technologies Holding Limited

(21) Appl. No.: 13/614,430

(22) Filed: Sep. 13, 2012

(51) Int. Cl. H04R 5/02

(52) U.S. Cl. 381/309

(57) ABSTRACT

A simulated sound field earphone includes a right ear unit, a left ear unit, a battery-containing analog sound field signal connective module and a simulated sound field selector. The right ear unit includes at least two sound generating units and the left ear unit also includes at least two sound generating units. Therefore, the sound field signal connective module can be used to select from at least two types of sound fields through the simulated sound field selector.

### BACKGROUND OF THE INVENTION

1. Field of the invention

The invention generally relates to an earphone. More particularly, the invention relates to a simulated sound field earphone, in which an analog sound field selector is provided to enable a user to have at least two types of sound fields.

2. Description of the prior art

In the conventional earphone, the earphone includes a right ear unit and a left ear unit. Each ear unit includes only a single sound generating unit. In addition, usually the right ear unit is electrically connected with the right audio signal output and the left ear unit is electrically connected with the left audio signal output; therefore, audio signals can not be played in a high-fidelity manner.

FIG. 1 is a view schematically illustrating a conventional earphone. The earphone comprises a right ear unit (1), a left ear unit (2), a wire connective module (3), wires (311, 314 and 315), a wire jacket (411), an insertion unit (501), a plug jacket (16) and two sound generating units (6 and 7).

### SUMMARY OF THE INVENTION

The simulated sound field earphone of the present invention comprises a right ear unit, a left ear unit, a battery-containing analog sound field signal connective module and a simulated sound field selector. The right ear unit comprises at least two sound generating units and the left ear unit also comprises at least two sound generating units. Therefore, the sound field signal connective module can be used to select from at least two types of sound fields, such as church music and dancing music, through the simulated sound field selector. Additional components, such as inductors, capacitors and resistors, may be added to modify the audio signals.

### BRIEF DESCRIPTION OF THE DRAWINGS

FIG. 1 is a view schematically illustrating a conventional earphone.

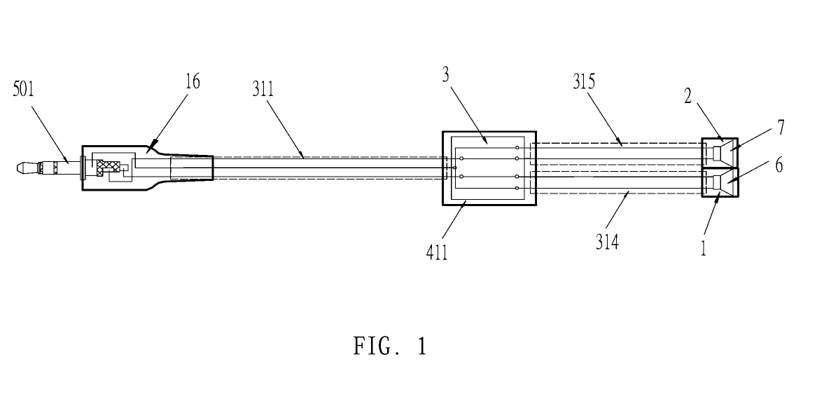

FIG. 2 is a view illustrating the electrical connection of a first embodiment of the present invention.

FIG. 3 is a view illustrating the electrical connection of a second embodiment of the present invention.

FIG. 4 is a view illustrating the electrical connection of a third embodiment of the present invention.

### DETAILED DESCRIPTION OF THE PREFERRED EMBODIMENTS

The features and advantages of the present invention will be introduced by the following detailed description and the according drawings.

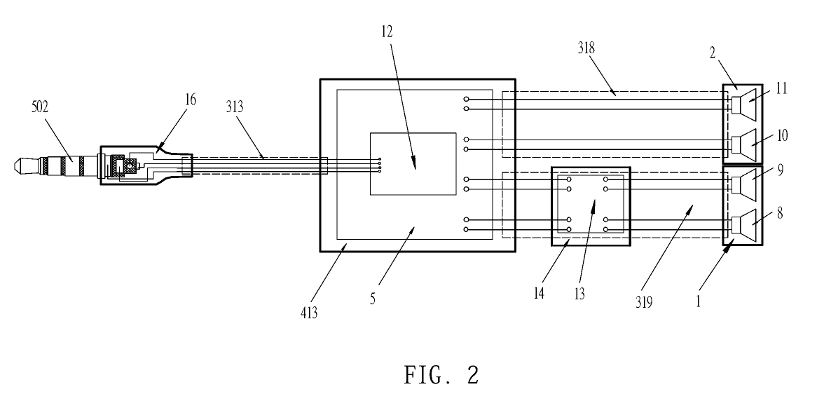

Please see FIG. 2, which illustrates a first embodiment of the present invention. In the first embodiment of the present invention, a right ear unit (1) comprises at least two sound generating units (8 and 9) and a left ear unit (2) comprises at least two sound generating units (10 and 11). A battery-containing analog sound field signal connective module (5) is provided between wires (318 and 319) and wires (313). A simulated sound field selector (12) is provided in the connective module (5) and a jacket (413) is provided to enclose and protect the connective module (5) and the simulated sound field selector (12). The jacket (413) may be manufactured by any suitable manufacturing method so that the connective module (5) and the simulated sound field selector (12) will not be damaged in normal usage.

At the distal end, a four-electrode insertion unit (502) is provided and is electrically connected with the wires (313). A jacket (16) protects the soldered junctures between the insertion unit (502) and the wires (313) and may be manufactured by any suitable manufacturing method. At the proximal end, the sound generating units (8, 9, 10 and 11) are soldered to the wires (318 and 319). A sound collecting module (13) and a jacket (14) may be optionally provided in the middle section of the wires (318) or the wires (319) according to the design of the simulated sound field selector (12).

The battery-containing analog sound field signal connective module (5) can be used to select from at least two types of sound fields, such as church music and dancing music simulation field, through the simulated sound field selector (12). As such, when the connective module 5 is connected to an earphone jack, if more than two sound fields are input from the source, the user using the simulated sound field earphone of the present invention can hear two sound simulations from each of the right and left ear units to enjoy the music.

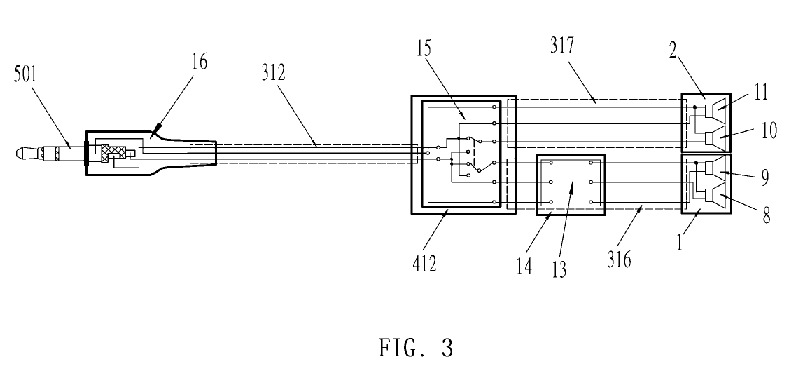

Please see FIG. 3, which illustrates a second embodiment of the present invention. In the second embodiment, the connective module (5) is simplified into a wire switching module (15), which includes a switching unit soldered to an ordinary circuit board; also, in the wire switching module (15), no battery is used but additional components, such as inductors, capacitors and resistors, may be added to modify the audio signals. A jacket (412) is provided to protect the wire switching module (15) and may be manufactured by any suitable manufacturing method. At the distal end, a three-electrode insertion unit (501) is provided and is electrically connected with the wires (312). A sound collecting module (13) and a jacket (14) may be optionally provided in the middle section of the wires (316) or the wires (317). In addition, in the second embodiment, instead of three-electrode insertion unit (501), a four-electrode insertion unit (502) as illustrated in FIG. 2 may be used to facilitate other additional function and, instead of three wires (312), four wires (313) as illustrated in FIG. 3 may be used. Therefore, in the second embodiment, the provision of the sound collecting module (13) and enclosure unit (14) is optional; the wires may be either three wires (312) or four wires (313) and respectively either the three-electrode insertion unit (501) or the four-electrode insertion unit (502) may be used. Therefore, the earphone of the present invention can provide the stereo sound effect as well as the selection of a second sound field.

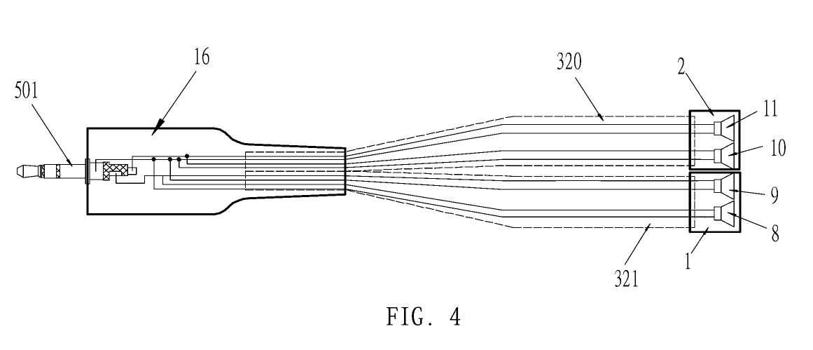

Please see FIG. 4, which illustrates a third embodiment of the present invention. In the third embodiment, the simulated sound field earphone of the present invention is further simplified. In the third embodiment, a right ear unit (1) comprises at least two sound generating units (8 and 9) and a left ear unit (2) comprises at least two sound generating units (10 and 11). The two sound generating units (8 and 9) are soldered to the wires (321) and the two sound generating units (10 and 11) are soldered to the wires (320). At the distal end, a three-electrode insertion unit (501) or a four-electrode insertion unit (502) (as illustrated in FIG. 2) is provided and is connected with the wires (320 and 321) by soldering. A jacket (16) covers and protects the soldered junctures between the insertion unit (502) and the wires (320 and 321) and may be manufactured by any suitable manufacturing method. Additional components, such as inductors, capacitors and resistors, may be added to modify the audio signals.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A simulated sound field earphone, comprising:
a right ear unit (1), including at least two sound generating units (8 and 9);
a left ear unit (2), including at least two sound generating units (10 and 11);
a plurality of connective wires (318, 319 and 313);
an insertion unit (501 or 502), provided at a distal end and electrically connected with a sound generating units through the connective wires (318, 319 and 313);
a battery-containing analog sound field signal connective module (5) provided between the connective wires (318, 319 and 313) and encompassed by a jacket (413); and
a simulated sound field selector (12), provided in the connective module (5),
wherein the battery-containing analog sound field signal connective module (5) is used to select from at least two types of sound fields through the simulated sound field selector (12).

2. A simulated sound field earphone, comprising:
a right ear unit (1), including at least two sound generating units (8 and 9);
a left ear unit (2), including at least two sound generating units (10 and 11);
a plurality of connective wires (318, 319 and 313);
an insertion unit (501 or 502), provided at a distal end and electrically connected with a sound generating units through the connective wires (318, 319 and 313); and
a wire switching module (15) provided between the connective wires (318, 319 and 313) and encompassed by a jacket (412), including a switching unit soldered to a circuit board;
wherein the wire switching module (5) is used to select from at least two types of sound fields through the switching unit.

3. A simulated sound field earphone, comprising:
a right ear unit (1), including at least two sound generating units (8 and 9);
a left ear unit (2), including at least two sound generating units (10 and 11);
a plurality of connective wires (318, 319 and 313); and
wherein at least two types of sound fields are provided to the right and the left ear unit (1 and 2).
